(19) United States
(12) Patent Application Publication
(10) Pub. No.: US 2003/0186123 A1
(43) Pub. Date: Oct. 2, 2003

(54) Process for the preparation of cathode materials, cathode materials prepared thereby and batteries containing said cathode materials

(76) Inventors: Trupti Maddanimath, Maharashtra (IN); Yogesh Baban Khollam, Maharashtra (IN); Imtiaz Mulla, Maharashtra (IN); Kunjukrishana Pillali Vijayamohanan, Maharashtra (IN)

Correspondence Address: Norman H. Stepno, Esquire, BURNS, DOANE, SWECKER & MATHIS, L.L.P., P.O. Box 1404, Alexandria, VA, 22313-1404, US

(21) Appl. No.: 10/108,418

(22) Filed: Mar. 29, 2002

(51) Int. Cl. H01M 4/58; B05D 5/12; H01M 4/66

(52) U.S. Cl. 429/213; 429/234; 427/58

(57) ABSTRACT

The present invention provides a process for making high energy density lithium rechargeable battery cathodes based on self-assembled monolayer. The cathode materials of the invention are prepared by immersing conducting substrates such as gold, silver, copper, and the like, in a milimolar solution of an organic disulfide. Thereby a self-assembled monolayer of an organic disulfides on a conducting substrate can be obtained capable of delivering high energy and power density after coupling with a material Lithium electrode anode in an electrolyte solution using Lithium salts and specific solvents and co-solvents.

### FIELD OF THE INVENTION

The present invention relates to an improved process for the preparation of cathode materials for high energy density rechargeable lithium batteries. More particularly the invention relates to an improved process for the preparation of self-assembled monolayer (SAM) based nano-sized cathode materials that are useful for high energy density rechargeable lithium batteries. The cathode materials prepared by the present invention are organic disulfides of monomolecular thickness on highly conducting substrates like gold, silver, copper, and the like which prove to be very useful in high energy density non-aqueous Lithium rechargeable batteries. More specifically, the present invention relates to an improved process for making high energy density Lithium rechargeable battery cathodes, based on self-assembled monolayer prepared by immersing the conducting substrates like gold, silver, copper etc. in a mili-molar solutions of organic disulfides (such as R—S—S—R₁ where, R and R₁ can be —CH₃, —C₂H₅, —C₆H₅ etc.) like diphenyl disulfide (DDS), naphthalene disulfide (NDS), diphenyl di-selenide (DDSe) etc. Thereby a self-assembled monolayer of an organic disulfides on a conducting substrate can be obtained capable of delivering high energy and power density after coupling with a material Lithium electrode anode in an electrolyte solution using Lithium salts and specific solvents and co-solvents. The present invention also relates to the cathode materials prepared by the process of the invention and to the use of such cathode materials in Li batteries.

### BACKGROUND OF THE INVENTION

Lithium rechargeable batteries have tremendous application potential as power sources because of their higher energy/power densities and long operational life times compared to other rechargeable batteries. Consequently Lithium rechargeable batteries are used routinely in our day today life for several electronic devices like laptop computers, cellular phones, electronic watches, calculations, cameras and metal oxide semiconductor memories along with other advantages of high energy and power density. High energy-density Lithium rechargeable batteries are also useful for the space and defense programs, for electric vehicles and for other consumer markets such as power sources for human implantable devices.

Lithium metal as an anode has low molecular weight, high standard electrode potential (3.045V), high charge density (3860 Ah/k6) and hence is one of the most attractive negative electrode materials for Lithium rechargeable batteries although limitations exist due to its high reactivity, poor reversibility and the need for handling in an inert atmosphere. Some of these limitations can be partly removed by using alternatives such as Li alloys (Li—Al, Li—Sn), Li-ion insertion anodes and more recently new compositions like (Science 276, 1395-1397 (1997) amorphous Sn based composites or even phases such as LiC6. Some of these are found to be very useful as anodes to replace Li metal, but development of a suitable rechargeable cathode to match the energy density still remains a challenge.

Different types of Lithium rechargeable battery cathodes are commercially available at present, but their performance does not meet all the goals required for the development of efficient high power density batteries. The main emphasis is on lightweight or low-density cathode material, small size and flexibility of fabrication of thin film which are some of the crucial aspects for optimizing the device performance along with long life time and room temperature operation with fast charging besides the low material cost. Several approaches are being made in world-wide in this direction, including the development of different types of compounds and mixtures for the secondary lithium battery cathode. The oxide of transition metal such as LiCoO₂, LiMn₂O₄, LiFeoO₂, LiNiO₂, V₂O₅, Cr₂O₅, MnO₂, MoO₂, WO₂, as well as the chalcogenides like TiS₂, MoS₂, FeS₂ have been tried by several investigators. Some of these compounds possessing either a layer or tunnel structure are fond to be very useful but performance deterioration is common with increasing the cycle life. One approach (JP No. 31408, dated Feb. 2, 1996) involves the preparation of compounds of the type Liₓ—A_{1-y}—M_{y}O₂ where A is Mn, Co and/or Ni and M is Mg, Ca etc. (where, 0.05≦X≦1.1, 0≦Y≦0.5) and this active material is mixed with an adhesive polymer and acetylene black to make the positive electrode paste. Such positive electrodes when used in non-aqueous lithium secondary cells are found to give no deterioration upon storage and more importantly, a high value of discharge capacity. Similarly superior reliability characteristics over a long duration of time (JP No. 9-7602 dated Jan. 10, 1997) was observed for LiₓMoO₂ active material pasted on an Al substrate grid with a 3 micron coating of metallic chromium. Other approaches being tried include the use of different types of intercalated compounds, conducting polymers, amorphous Mn-based oxyiodide compound [Nature 390, 265-267 (1997)] etc for enhancing the performance of the cathode in Lithium rechargeable battery.

Conventional cathode materials also exhibit several drawbacks such as low capacity at moderate current density, surface degradation and grain growth during cycling and also in open circuit stand (in case of bulk material, where surface becomes quite different from the bulk), high rate of self discharge due to parastic corrosion reactions and finally a large ohmic drop due to the formation of insulting phases. Further, the problems like poor mechanical strength, poor utilization efficiency, relatively slow transfer of Li+ ions, large ohmic drop etc. arise due to the use of external additives like graphite or acetylene black and also the polymeric binders during the cathode fabrication.

Recently, conducting polymer based cathode materials including several organo-inorganic nanocomposites have been found to be promising to alleviate some of these difficulties so that high energy density and improved cycle life can be obtained. However, most of such materials still show capacity failure during continuous cycling and more significantly, poor Li⁺ transport limits their high rate capability. Therefore, the development of cheaper, environmentally being and lightweight rechargeable cathodes having energy/power density and long life is desired to manufacture reliable and economical lithium cells.

On the other hand self-assembled monolayers are close packed arrays of amphiphilic molecules like long chain thiols and disulfides where the high coverage (10¹²-10¹³ molecules/cm₂) and monomolecular thickness can be used to design optimum energy/weight or energy/volume parameters. Easy method of preparation, reproducible film quality, good stability and control of the chain length to get desired wetting and adhesion properties, etc. are the main advantages of self-assembled monolayers. Due to these reasons, self-assembled monolayer finds tremendous applications in various areas such as corrosion protection, wetting, friction, adhesion, microelectronics and molecular electronics, optics, chemical sensors, etc. However, the use of these well ordered monolayer on a conducting substrates as cathode material for secondary Li-batteries, despite the possibility of full utilization for a faradic reaction, has not been unfortunately studied, perhaps due to the insulating nature of normal self-assembled monolayer forming molecule like long chain thiols.

### OBJECTS OF THE INVENTION

The main object of the present invention is to provide an improved process for the preparation of cathode materials for high energy density rechargeable lithium batteries.

It is another object of the invention to provide a cathode layer in monolayer of monomolecular thickness and thereby avoid surface degradation or growth during cycling and also in open circuit stand.

It is another object of the invention to provide cathode materials which do not result in a large ohmic drop at moderate current density.

It is a further embodiment of the invention to provide a self assembled monolayer of disulfides on the conducting substrates itself as the cathodes for Li-cell, thereby avoiding the addition of graphite or acetylene black for increase in conductivity and of binder like Teflon for Li-cell formulation, and thereby avoiding poor mechanical strength, poor utilization efficiency, relatively slow transfer of Li+ ions, etc. that arise due to use of external additives.

It is another object of the invention to provide a cathode materials for Li-batteries which are self assembled monolayers thus resulting in significant weight reduction of resultant cathodes and hence of Li-cell.

### SUMMARY OF THE INVENTION

The above and other objects of the invention are achieved by the process of the present invention for making high energy density lithium rechargeable battery cathodes based on self-assembled monolayer. The cathode materials of the invention are prepared by immersing conducting substrates such as gold, silver, copper, and the like, in a milimolar solution of an organic disulfide (of the formula R—S—S—R₁ where R and R₁ are —CH₃, —C₂H₅, —C₆H₅ and the like). Thereby a self-assembled monolayer of an organic disulfides on a conducting substrate can be obtained capable of delivering high energy and power density after coupling with a material Lithium electrode anode in an electrolyte solution using Lithium salts and specific solvents and co-solvents.

Accordingly, the present invention provides an improved process for the preparation of a cathode material for high energy density rechargeable lithium batteries which comprises preparing a milimolar solution of an organic disulfide in an organic solvent, cleaning the conducting substrate to remove oxide impurities present on the surface thereof, rinsing the substrate extensively with an organic solvent, immersing the substrate in the disulfide solution to obtain a monolayer, washing the monolayer modified substrate extensively with the solvent, till it is free from unadsorbed disulfide molecules, drying in a inert atmosphere to obtain the cathode material.

In one embodiment of the invention, the substrate is immersed in the disulfide solution for a time period in the range of 17 to 24 hours.

In another embodiment of the present invention the organic disulfide used as the material for monolayer preparation is selected from aromatic and aliphatic alkane dithiols.

In another embodiment of the invention, the organic disulfide is selected from diphenyl disulphide (DDS), diphenyl di-selenide (DDSe) and naphthalene disulphide (NDS).

In another embodiment of the invention, the conducting substrate used for monolayer preparation comprises a metal coated non-conducting material.

In a further embodiment of the invention, the metal coating on the non-conducting material is selected from gold, silver and copper.

In another embodiment of the invention, the non-conducting material comprises glass.

In another embodiment of the invention, the conducting substrate comprises a metal selected from the group consisting of copper, silver and gold, preferably copper.

In another embodiment of the invention, the organic solvent used for the preparation of solutions of monolayer materials is selected from the group consisting of acetone, ethanol, butanol, benzene and isopropanol.

In yet another embodiment of the invention, the surface of the substrate is cleaned of oxide impurities using a dilute inorganic acid.

In yet another embodiment of the invention, the dilute inorganic acid solution used for cleaning oxide impurities is selected from 85% H₃PO₄ and 97% H₂SO₄.

In yet another embodiment of the invention, the inert atmosphere for drying the substrate modified disulfides and for Li-cell fabrication is created using nitrogen, argon or helium.

The invention also relates to a cathode material for use in high energy density rechargeable lithium batteries comprising a substrate modified with a monolayer of an organic disulfide adsorbed thereon.

In one embodiment of the invention, the substrate comprises a non-conducting material coated with a metal selected from the group consisting of copper, gold and silver.

In another embodiment of the invention, the non-conducting material comprises glass.

In a further embodiment of the invention, the substrate comprises a metal layer selected from the group consisting of gold, silver and copper layers.

In yet another embodiment of the invention, the organic disulfide is selected from aromatic and aliphatic alkane dithiols.

In another embodiment of the invention, the organic disulfide is selected from diphenyl disulphide (DDS), diphenyl di-selenide (DDSe) and naphthalene disulphide (NDS).

In another embodiment of the invention, the cathode material obtained is moulded into any desired shape depending on the physical parameters of the batteries wherein the cathode material is to be used.

The invention also relates to the use of cathode material prepared by the process of the invention in high energy density lithium batteries.

### DETAILED DESCRIPTION OF THE INVENTION

The invention provides an improved process for the preparation of self-assembled monolayer (SAM) based nano-sized cathode materials that are useful for high energy density rechargeable lithium batteries. The cathode materials prepared are organic disulfides of monomolecular thickness on highly conducting substrates like gold, silver, copper, and the like which prove to be very useful in high energy density non-aqueous Lithium rechargeable batteries. The cathode materials of the invention are prepared by immersing the conducting substrates like gold, silver, copper etc. in a mili-molar solutions of organic disulfides (such as for example of the formula R—S—S—R₁ where, R and R₁ are —CH₃, —C₂H₅, —C₆H₅ etc.) like diphenyl disulfide (DDS), naphthalene disulfide (NDS), diphenyl di-selenide (DDSe) etc. Thereby a self-assembled monolayer of an organic disulfides on a conducting substrate can be obtained capable of delivering high energy and power density after coupling with a material Lithium electrode anode in an electrolyte solution using Lithium salts and specific solvents and co-solvents.

The process of the invention comprises preparing a milimolar solution of an organic disulfide in an organic solvent. The organic substrate is then cleaned to remove any oxide impurities present thereon on the surface. The cleaned substrate is then rinsed thoroughly in an organic solvent and then immersed in the disulfide solution to obtain a monolayer. The monolayer is then washed extensively with the solvent till it is free from unadsorbed disulfide molecules and then dried in an inert atmosphere to obtain the cathode material. The immersion is preferably carried out for 17 to 24 hours. The organic disulfide used for immersing the substrate is preferably selected from aromatic or aliphatic alkane dithiols. Preferred organic disulfides include diphenyl disulphide (DDS), diphenyl di-selenide (DDSe) and naphthalene disulphide (NDS).

The substrate can be either a non-conducting material such as glass coated with a metal such as gold, silver or copper or the metal itself directly. Of the various metals that can be used, copper is the most preferred. The organic solvent used for preparing the monolayer materials preferably is acetone, ethanol, butanol, benzene and isopropanol. The monolayer modified substrate is preferably dried in an inert atmosphere created using helium, nitrogen or argon.

The cathode material obtained is moulded into any desired shape depending on the physical parameters of the batteries wherein the cathode material is to be used.

The disulfide monolayer modified conducting substrate when immersed in an electrolyte solution of Lithium salt like lithium perchlorate (LiCIO₄), lithium hexafluroarsenate (LiAsF₆), lithium hexaflurophosphate (LiPF₆), lithium chloride (LiCI) etc. and coupled with an anode selcted from Li metal, Li—Al or Li—Sn alloy, LiC₆, etc. shows an open circuit voltage (OCV) ranging from 2.98 to 3.5V. When charge-discharge cycling was conducted at either constant current or constant potential mode different energy as power density values were observed depending on the self assembled monolayer material composition. The capacity values were found to be invariant with respect to cycle number and some typical values corresponding to a galvanostatic discharge at 0.03 mA/cm² are indicated in the accompanying Table-1.

The process of the present invention is explained in details in the following examples, which are given by way of illustration only and therefore should not be construed to limit the scope of the present invention in any manner.

### EXAMPLE 1

Copper foils having 1 cm² area were polished by silicon carbide abrasive paper followed by etching with phosphoric acid/sulfuric acid solution (130 ml of 85% H₃PO₄, 20 ml of 97% H₂SO₄ and 60 ml of H₂O) for removal of oxide impurities present on the surface. Subsequently, they were rinsed extensively with acetonitrile and dried prior to the monolayer formation. These dry substrates were then immersed in 1 mM solution of DDS for 24 h to get well-organized monomolecular film. The substrates were removed from the DDS solution and washed repeatedly with the acetonitrile solvent and then dried in a stream of argon gas. The total exposed surface area (bilateral) was 2 cm². The DDS modified copper substrates were used as positive electrode in Li cell fabrication. DDS SAM functionalised copper electrodes as cathode were coupled with a large area Li metal anode using 0.1M LiClO₄ in Tetrahydrofuran (THF) as an electrolyte to fabricate Li cells. 0.03 mA/cm² current density was used for charge discharge studies. The open circuit voltage was observed to be in the range of 2.9-3.1 V. The results are summarized in the Table-1.

### EXAMPLE 2

Gold substrates were cleaned with Piranha's solution before monolayer formation. The gold substrates were modified with SAM as per the procedure described in example 1. These DDS modified gold substrates were used as positive electrode in Li cell fabrication. DDS SAM functionalized gold electrodes as cathode were coupled with a large area Li metal anode using 0.1M LiClO₄ in THF as the electrolyte to fabricate Li cells. Charge-discharge measurements were carried out using current density of 0.03 mA/cm².

### EXAMPLE 3

Monolayer of NDS was formed on copper substrate by using one milimolar solution of NDS in acetonitrile. Charge-discharge measurements were carried out as per previous example and result is included in Table 1.

### EXAMPLE 4

Charge-discharge measurements of DDS SAM on copper substrate were carried out similar to procedure given in example 1. DDS SAM functionalized copper electrodes as were coupled with a large area Li metal anode using 0.1M LiAsF₆ in THF as an electrolyte to fabricate Li cells. Current density used for measurements was 0.03 mA/cm². Results obtained are summarized in Table 1.

TABLE 1
Discharge Capacity for a first cycle at a current density of 0.03 mA/cm²

| | | Discharge Capacity |
|---|---|---|
| Sr. No. | Cathode Material | (Ah/Kg) × 10⁵ |
| 1 | Cu modified DDS SAM | 400 |
| 2 | Au modified DDS SAM | 460 |
| 3 | Cu modified NDS SAM | 420 |
| 4 | Cu modified DDS SAM | 430 |
| | using 0.1 M LiAlF₆ | |

Advantages of the Invention

1. Extremely high capacity (10 times higher than conventional cathodes) at moderate current density.

2. The cathode material formed is a monolayer of monomolecular thickness and therefore there is no question of surface degradation or growth during the cycling and also in open circuit stand.

3. There is no large ohmic drop at the moderate current density.

4. Self assembled monolayer of disulfides on the conducting substrates, itself are the cathodes for Li-cell, hence there is no question of addition of graphite or acetylene black for increase in conductivity and of binder like Teflon for Li-cell formulation. Therefore the problems like poor mechanical strength, poor utilization efficiency, relatively slow transfer of Li⁺ ions, etc. arise due to the use of these external additives are automatically solved.

5. Since the cathode material is a self assembled monolayer there is a significant weight reduction of resultant cathodes and hence of Li-cell.

We claim:

1. A process for the preparation of a cathode material for high energy density rechargeable lithium batteries which comprises preparing a milimolar solution of an organic disulfide in an organic solvent, cleaning the conducting substrate to remove oxide impurities present on the surface thereof, rinsing the substrate extensively with an organic solvent, immersing the substrate in the disulfide solution to obtain a monolayer, washing the monolayer modified substrate extensively with the solvent, till it is free from unadsorbed disulfide molecules, drying in a inert atmosphere to obtain the cathode material.

2. A process as claimed in claim 1 wherein the substrate is immersed in the disulfide solution for a time period in the range of 17 to 24 hours.

3. A process as claimed in claim 1 wherein the organic disulfide used as the material for monolayer preparation is selected from aromatic and aliphatic alkane dithiols.

4. A process as claimed in claim 1 wherein the organic disulfide is selected from diphenyl disulphide (DDS), diphenyl di-selenide (DDSe) and naphthalene disulphide (NDS).

5. A process as claimed in claim 1 wherein the conducting substrate used for monolayer preparation comprises a metal coated non-conducting material.

6. A process as claimed in claim 5 wherein the metal coating on the non-conducting material is selected from gold, silver and copper.

7. A process as claimed in claim 5 wherein the non-conducting material comprises glass.

8. A process as claimed in claim 1 wherein the conducting substrate comprises a metal selected from the group consisting of copper, silver and gold.

9. A process as claimed in claim 1 wherein the conducting substrate comprises copper.

10. A process as claimed in claim 1 wherein the organic solvent used for the preparation of solutions of monolayer materials is selected from the group consisting of acetone, ethanol, butanol, benzene and isopropanol.

11. A process as claimed in claim 1 wherein the surface of the substrate is cleaned of oxide impurities using a dilute inorganic acid.

12. A process as claimed in claim 11 wherein the dilute inorganic acid solution used for cleaning oxide impurities is selected from 85% H₃PO₄ and 97% H₂SO₄.

13. A process as claimed in claim 1 wherein the inert atmosphere for drying the substrate modified disulfides and for Li-cell fabrication is created using nitrogen, argon or helium.

14. A cathode material for use in high energy density rechargeable lithium batteries comprising a substrate modified with a monolayer of an organic disulfide adsorbed thereon.

15. A cathode material as claimed in claim 14 wherein the substrate comprises a non-conducting material coated with a metal selected from the group consisting of copper, gold and silver.

16. A cathode material as claimed in claim 15 wherein the non-conducting material comprises glass.

17. A cathode material as claimed in claim 14 wherein the substrate comprises a metal layer selected from the group consisting of gold, silver and copper layers.

18. A cathode material as claimed in claim 14 wherein the organic disulfide is selected from aromatic and aliphatic alkane dithiols.

19. A cathode material as claimed in claim 14 wherein the organic disulfide is selected from diphenyl disulphide (DDS), diphenyl di-selenide (DDSe) and naphthalene disulphide (NDS).

20. A cathode material as claimed in claim 14 wherein the cathode material obtained is moulded into any desired shape depending on the physical parameters of the batteries wherein the cathode material is to be used.

21. Use of cathode material prepared by the process of the invention in high energy density lithium batteries.
